(19) United States
(12) Patent Application Publication
(10) Pub. No.: US 2026/0307818 A1
(43) Pub. Date: Oct. 8, 2026

(54) CONTROL DEVICE FOR A SAFETY-CRITICAL ACTUATOR

(71) Applicant: Liebherr-Aerospace Lindenberg GmbH, Lindenberg (DE)

(72) Inventors: Sven THIERER, Weiler-Simmerberg (DE); Thomas LANZ, Neukirch (DE); Leon ROOS, Lindenberg (DE)

(21) Appl. No.: 19/638,565

(22) Filed: Apr. 3, 2026

(30) Foreign Application Priority Data
Apr. 4, 2025 (DE) 10 2025 113 318.2

(51) Int. Cl. B64D 45/00; G07C 5/00; G07C 5/08

(52) U.S. Cl. CPC B64D 45/00; G07C 5/008; G07C 5/0808; G07C 5/0816; B64D 2045/0085

(57) ABSTRACT

A control device for a safety-critical actuator comprises a first control unit, a second control unit, and an activation unit configured to place either the first control unit or the second control unit together with the received actuator state signal into a control state, and to place the other control unit into a monitoring state. The activation unit has a signal input for receiving an assignment signal of an external source, and is configured to terminate the control state from the control unit in the control state to the control unit in the monitoring state when both the monitoring signal of the control unit in the monitoring state and the assignment signal of the external source indicate a malfunction of the control unit in the control state.

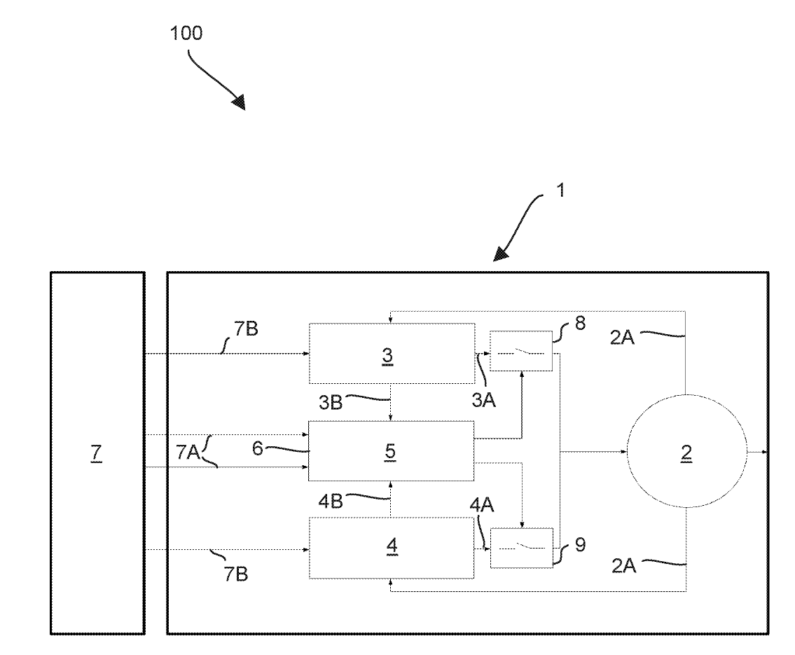

### CROSS REFERENCE TO RELATED APPLICATIONS

The present application claims priority to German Patent Application No. 10 2025 113 318.2 filed on Apr. 04, 2025. The entire contents of the above-listed application are hereby incorporated by reference for all purposes.

### TECHNICAL FIELD

The present disclosure relates to a control device for a safety-critical actuator, as used in particular in the field of aviation.

### BACKGROUND

In modern aircraft, numerous actuators are installed, for example for operating high-lift systems, for adjusting primary flight control surfaces, or for extending the aircraft landing gear. These actuators play a central role in the safe control and stabilization of an aircraft, so that a failure or incorrect actuation can lead to serious impairments in flight operations, up to and including potential hazards for passengers and crew.

### SUMMARY

In order to prevent such risks, the control devices for safety-critical actuators must satisfy high safety requirements. In particular, it is essential that at least two mutually independent control units are present in order to be able to ensure safe actuation even in the event of a failure of one of the two control units. A redundant design with, for example, two channels (wherein each channel is routed via a respective control unit) ensures that, if a control unit fails or malfunctions, the respective other unit can continue to assume control. This principle primarily serves the objective of achieving the highest possible degree of operational reliability and fault tolerance, as specified by the relevant certification authorities in aviation but also in other fault-intolerant environments.

The prior art often provides a so-called 2×2 dissimilar channel configuration, wherein four independent channels (with a total of four independent control units) are integrated.

The four channels are divided into two channel pairs, so that one channel of each pair can assume a control state and the respective other channel can assume a monitoring state. If a channel in the monitoring state then determines that the channel it monitors that is in the control state is possibly acting erroneously, a switch is made to the other channel pair. As stated, the channels of the channel pair assume different tasks in the form of control and monitoring.

Although high safety standards are achieved thereby, this approach is associated with various disadvantages. Thus, a 2×2 architecture with its total of four channels (and consequently also four control units) requires a lot of space, which represents a considerable challenge particularly in confined aircraft systems. The high weight, the high energy consumption, and the costs for required hardware components also have a negative impact. In addition, an error in one of the channels results in an immediate disregard of the channel pair regarded as faulty, and this is also the case if a channel in the monitoring state erroneously reports the fault state and, as a result, an unnecessary shutdown of the channel pair occurs.

The present disclosure overcomes this problem or at least mitigates it by providing, by means of a control device as described herein, a more compact, more energy-efficient, and more cost-effective solution which at the same time ensures a high degree of operational reliability and fault tolerance.

Further advantageous embodiments are also described herein.

The control device according to the disclosure for a safety-critical actuator comprises a first control unit which is configured to output a control signal for actuating the actuator and a monitoring signal on the basis of at least one state signal of the actuator fed back to the first control unit, a second control unit which is configured to output a control signal for actuating the actuator and a monitoring signal on the basis of at least one state signal of the actuator fed back to the second control unit, and an activation unit which is configured to place either the first control unit or the second control unit into a control state (CON), in which the output control signal is forwarded to the actuator, and to place the other control unit into a monitoring state (MON), in which the output control signal is not forwarded to the actuator, wherein the activation unit is configured to receive and evaluate the monitoring signal of the first control unit and the monitoring signal of the second control unit in order, depending thereon, to assign the control state to the first control unit or to the second control unit. The device is characterized in that the activation unit has a signal input for receiving at least one assignment signal from at least one external source, wherein the activation unit is configured to switch the control state from the control unit that is in the control state to the control unit that is in the monitoring state when both the monitoring signal of the control unit that is in the monitoring state and the assignment signal of the external source indicate a malfunction of the control unit that is in the control state.

Optionally, there are two assignment signals from at least one external source.

This claim defines a dual architecture in which two control units can optionally be operated in a control state (CON) or in a monitoring state (MON). As a rule, one of the two control units is in the control state (CON) and the other is in the monitoring state (MON). The monitoring signal of the one unit prevents premature deactivation of the unit currently controlling, since switching takes place only in the event of a confirmed malfunction via the assignment signal of the external source. As a result, higher reliability is achieved in safety-critical applications, because neither a fault state signalized solely by the control unit in the monitoring state nor the corresponding signal of the external source alone brings about a corresponding consequence, for example the switching of the control unit that is in the control state. For this purpose, a matching signalization of the control unit in the monitoring state as well as of the external source is always required, both of which allow the conclusion of a malfunction of the control unit that is in the control state. As a result, the required match in the two signals indicating a malfunction ensures that a switch to the previously monitoring unit is triggered only when the external source and the monitoring function agree.

It may be advantageous here that, in contrast to the prior art, it is now no longer the case that a total of four control units (in technical jargon also called: lanes) are required, but rather only two control units as well as the activation unit, which is capable of receiving the assignment signal of the external source.

According to an optional modification of the present disclosure, it may be provided that the first control unit and the second control unit are designed redundantly with respect to one another, in particular designed heterogeneously redundant or homogeneously redundant with respect to one another, and/or each have a signal input for receiving an actuator setpoint signal from the external source.

Each of the two control units receives an actuator setpoint signal via a signal input, which as a rule is provided by the external source. The respective control unit that is in the control state then forwards the control signal based on the actuator setpoint signal to the actuator to be controlled. Furthermore, it may also be provided that the control unit that is in the monitoring state likewise generates and outputs a control signal based on the actuator setpoint signal, but the activation unit ensures that the control signal output by the control unit in the monitoring state does not reach the actuator.

In other words, it may thus be provided that each of the two control units operates identically regardless of whether it is in a control state or in a monitoring state. Ultimately, a control unit does not perceive whether it is in a control state or in a monitoring state, since the decision thereon is made by the activation unit by forwarding, or not, the control signals output by a respective control unit to the actuator. The activation unit also decides whether a monitoring signal transmitted to it by a respective control unit is used for a change of the state assignments or not. Thus, it may be advantageously provided that the activation unit does not use a monitoring signal of a control unit that is in the control state, but does so only for the monitoring signal of the control unit that is in the monitoring state.

By the redundant design of both control units, an additional safety level is created, because at least one functioning unit can assume control. Whether the redundancy is homogeneous or heterogeneous enables different technical implementation possibilities, which provides flexibility in design and costs. Moreover, a heterogeneous configuration of the redundancy is advantageous with regard to fault tolerance, since system-related errors then have a lower probability of leading to a simultaneous failure of both control units.

According to an optional modification of the present disclosure, it may be provided that the activation unit is designed separately from the two control units or is designed integrated into one or both of the control units.

The activation unit can, depending on the requirements, be implemented either as a standalone assembly or integrated in one (or both) of the control units. This creates leeway in the system architecture, so that manufacturers can select the suitable solution depending on space, cost, or safety aspects. This allows flexible adaptation to different aircraft types or safety-critical applications.

According to a further optional modification of the present disclosure, it may be provided that the activation unit is configured to carry out, as a function of the assignment signal, an initial assignment of control state and monitoring state to the first control unit and the second control unit.

From this it follows that an initial allocation of control state and monitoring state is effected by the assignment signal. As a result, it can already be unambiguously defined at system start which control unit outputs the control signal and which monitors. This reduces misconfigurations and makes the start-up process more efficient and safer. Thus, an unambiguous basic configuration is created on which the system can build during operation. It may further be provided that the external source performs the initial assignment in such a way that the two control units alternately receive the control state and the monitoring state, since this reduces the probability of a latent fault in which the control unit in the monitoring state outputs incorrect control signals undetected.

According to a further possible development of the present disclosure, it may be provided that, after a switching of the control state from the control unit in the control state to the control unit in the monitoring state, the activation unit is configured to place the control unit from which the control state has been withdrawn into a fault state (FAIL), optionally wherein the monitoring signal of a control unit in the fault state is not taken into account by the activation unit when assigning the control state.

Here, the automatic transition of a previously controlling control unit into a fault state (FAIL) is described as soon as the other unit assumes the control state. This helps to consistently exclude faulty units from relevant control and monitoring processes. As a result, a defective control unit can no longer send incorrect signals and jeopardize system stability. The monitoring signals of an already failed unit are advantageously not taken into account, which prevents unnecessary false alarms.

According to a further possible modification of the present disclosure, it may be provided that the activation unit includes a first switching unit, which is configured to establish or interrupt a signal connection between the first control unit and the actuator (or a corresponding signal connection for the actuator), and a second switching unit, which is configured to establish or interrupt a signal connection between the second control unit and the actuator (or a corresponding signal connection for the actuator), for example wherein the first switching unit and the second switching unit are each designed as a switch, relay, or the like actuated by the activation unit.

Optionally, it is provided that the two existing switching units always have mutually inverse switching states, so that only one of the two switching units establishes a connection to the actuator and the other interrupts a connection to the actuator.

With a first and second switching unit which control signal connections from the respective control unit to the actuator, the line paths can be flexibly opened or closed. As a result, the activation unit can specifically control the transmission of control signals to the actuator. This increases fault tolerance, since only the respectively enabled lane is physically switched through to the actuator.

According to a further optional development of the present disclosure, it may be provided that the safety-critical actuator is an actuator in an aircraft, and for example is a high-lift system, an actuator for adjusting a primary flight control surface, a flight control element, or an aircraft landing gear of an aircraft.

The mention of an actuator in an aircraft, for example for high-lift systems, primary flight control surfaces, or landing gear, underscores the safety-critical relevance of the device, which is of outstanding importance particularly for an aircraft. Reliability and fault tolerance are particularly important in this field. As a result, the claim emphasizes suitability for highly sensitive applications in the aviation industry, which increases the economic and technical significance of the disclosure. Of course, the present application can also be of great use in any other fields, for example in the automotive sector or wherever safety-critical actuators are used.

The disclosure further relates to a system for actuating a safety-critical actuator, which comprises a device according to one of the aspects discussed above, and an external source which is coupled to the activation unit via the signal input, optionally wherein the external source is a control computer.

By supplementing the device with the external source, a complete system is formed in which the activation unit and the control units function together. The external source is coupled directly to the signal input and thus assumes a central role in the assignment of CON and MON states. The interaction of the device and the external source increases overall efficiency and enables coherent control from a higher-level instance.

Furthermore, it may optionally be provided that the external source is configured to transmit an actuator setpoint signal for actuating the actuator to the device, optionally wherein both the first control unit and the second control unit receive the identical actuator setpoint signal for outputting a control signal based thereon.

By transmitting an actuator setpoint signal to both control units, each lane can in parallel prepare the (in the fault-free state) identical or at least functionally equivalent control signal. This increases fault tolerance, since in the event of a fault the previously monitoring unit can assume the control signal without latency. The parallel reception of the actuator setpoint signal ensures that no time is lost to retrieve new commands, which could be safety-relevant in time-critical application situations. As a result, the system is more responsive than a system in which the reception and/or generation of a control signal on the basis of the actuator control signal is performed only when the underlying control unit is placed into the control state.

In addition, it may optionally be provided that the external source is configured to send an assignment signal via the signal input to the activation unit in order to initially assign the control state (CON) and the monitoring state (MON) to the first control unit and the second control unit, respectively.

The possibility of initially assigning the control state (CON) or the monitoring state (MON) already to the first and second control units prevents mix-ups or conflicts at system start. This increases process reliability and simplifies commissioning, because the external source specifies a clear assignment at the beginning. In this way, a contradiction-free operating state is ensured, which keeps subsequent control stable.

In addition, the external source can be configured to provide, at each initial assignment, that the control state or the monitoring state alternates between the two control units.

According to a further advantageous modification of the present disclosure, it may be provided that the external source is configured to send, via the signal input, an assignment signal to the activation unit which indicates a malfunction of the control unit in the control state.

The external source can send an assignment signal which specifically indicates a malfunction of a control unit currently controlling. Thus, the flow of information from outside into the system is strengthened once again, because not only internal monitoring signals are evaluated. The integration of the external malfunction signal accelerates the possible switch to a functioning unit. Thus, the system becomes even safer, since in the event of a confirmed malfunction it can react more quickly.

According to a further advantageous development of the present disclosure, it may be provided that the activation unit is configured to switch the control state from the control unit in the control state to the control unit in the monitoring state only when both the monitoring signal of the control unit in the monitoring state and the assignment signal of the external source indicate a malfunction of the control unit in the control state.

Here it is clarified that a state change occurs only when both parties (external source and MON) detect a fault. This protects against premature shutdown due to an erroneous measurement or disturbance in only one component (for example only the external source or only the control unit which is in the monitoring state). Thus, unnecessary downtime is avoided and the system remains stable. This safeguard minimizes the risk of unintended deactivation of the unit in the control state on the basis of a possibly erroneous indication of a malfunction of the control unit in the control state.

Furthermore, it may be provided that the external source is also configured to receive at least one state signal of the actuator, in order to generate, on the basis of at least one state signal of the actuator fed back to the external source, an indication of a malfunction of the actuator relative to an actuator setpoint signal given by the external source to the control device. Optionally, it is provided that the external source is configured to send a corresponding signal indicating a malfunction as an assignment signal to the activation unit.

According to a further development of the present disclosure, it may be provided that the external source is a flight control computer which is coupled to the control device via a communication bus.

The specific indication that the external source can be a flight control computer makes clear the application case in the field of aviation. The coupling via a communication bus shows an established interface technology, whereby the system can be easily integrated into existing aircraft infrastructures. This increases practicability and facilitates implementation as well as certification. Moreover, it becomes clear that the system is compatible with common avionics standards.

Optionally, it may be provided that the system further comprises an actuator which is configured to receive a control signal from a control unit in the control state and to send at least one state signal to both the first control unit and the second control unit.

The integration of an actuator illustrates the continuous control and monitoring process, since the same actuator both receives the control signal and reports a state signal back. This creates transparency regarding the actual operating state and allows continuous functional monitoring. Thus, problems can be detected early, which contributes to reducing the probability of failure. At the same time, a continuous data chain between external computer, control units, and actuator is established.

The disclosure further relates to an aircraft, for example an airplane, having a device according to one of the aspects discussed above or a system according to one of the aspects discussed above.

Integration into an aircraft may be advantageous due to the high requirements for fault tolerance prevailing there, which apply specifically in the field of airplanes. Since the highest safety and reliability requirements apply here, use in an aircraft highlights the high safety level of the device.

### BRIEF DESCRIPTION OF THE FIGURE

Further features, details, and advantages of the disclosure will be apparent from the following description of the figure. Therein is shown:

The Figure is a schematic representation of the present disclosure together with the external source and the actuator.

### DETAILED DESCRIPTION

The Figure shows a schematic representation of a system 100 for actuating a safety-critical actuator 2. The illustrated system comprises a device 1 for actuating the actuator 2 as well as an external source 7 and the actuator 2 itself.

Two control units 3, 4 are shown, each of which is capable of outputting, on the basis of an actuator setpoint signal 7A output by the external source 7, a respective control signal 3A, 4A which serves to actuate the actuator 2.

In order to ensure that only one of the control signals 3A, 4A generated in parallel is applied to the actuator 2, only one of the two control signals 3A, 4A generated in parallel is applied to the actuator 2 with the aid of the activation unit 5. For this purpose, the activation unit 5 can have a respective switching unit 8, 9 in the connection line between control unit 3, 4 and actuator 2. In a simple embodiment, the switching unit 8, 9 is a switch which, depending on its switching state, forwards the control signal generated by the associated control unit 3, 4 to the actuator 2 or isolates it therefrom.

The control unit 3, 4 whose control signal is used for actuating the actuator 2 is in the so-called control state (also called: CON, for English: control). In other words, the control signal output by the control unit 3, 4 in the control state is used for actuating the actuator 2.

The other control unit 3, 4 is then typically in the so-called monitoring state (also called: MON, for English: monitor) and contributes to monitoring the control unit 3, 4 in the control state.

However, a control unit 3, 4 in the monitoring state also outputs corresponding control signals 3A, 4A, but the activation unit 5, with its respective switching unit 8, 9, ensures that the control signals output by the control unit 3, 4 in the monitoring state do not reach the actuator 2. Nevertheless, the control unit 3, 4 in the monitoring state operates in the same manner as the one in the control state.

It can further be seen that the actuator 2 sends a state signal 2A to each of the two control units 3, 4, so that each of the two control units 3, 4, on its own, can check whether the actuator 2 responds in accordance with the output control signal 3A, 4A or whether a fault state is to be assumed.

This information is then transmitted to the activation unit 5 in the form of a monitoring signal 3B, 4B, which essentially contains the information according to which the respective control unit 3, 4 in the monitoring state concludes that the control unit 3, 4 in the control state is malfunctioning, or that no such malfunction is detected.

In addition, the external source 7 can also be seen, which transmits an actuator setpoint signal to both control units 3, 4. This actuator setpoint signal 7B is identical for both control units 3, 4.

The external source 7 also sends an assignment signal 7A to the input 6 of the activation unit 5 in order, at the beginning, to assign an initial assignment of control state and monitoring state to the two control units 3, 4 and, thereafter, to indicate a malfunction of the control unit 3, 4 in the control state perceived by the external source 7.

Shown in the Figure are two separate lines for transmitting the assignment signal 7A; however, this does not necessarily have to be the case, rather a single line for transmitting the assignment signal 7A of the external source 7 to the signal input 6 of the activation unit 5 is sufficient.

In this context, the control state is withdrawn only if both the control unit 3, 4 in the monitoring state and the external source 7 signal to the activation unit 5 (via the monitoring signal 3B, 4B and the assignment signal 7A, respectively) that the control unit 3, 4 in the control state has a malfunction.

An immediate feedback of the actuator 2 to the external source 7, in which a state signal of the actuator 2 is transmitted, is not shown here (but is of course possible), since the external source 7 can also learn, via other information paths, whether the actuator 2 (in the view of the external source 7) functions correctly.

If the actuator 2 serves, by way of example, to actuate a rudder of an airplane, the external source 7 can conclude a faulty state of the control unit in the control state if the desired rotation about the vertical axis of the airplane has not occurred, although, as experience shows, the actuator setpoint signal 7B sent to the control units 3, 4 should have been sufficient for this. For this purpose, the external source 7 could use an inertial system, a compass, or the like for comparison.

If both the external source 7 and the control unit 3, 4 which is in the monitoring state detect a fault state of the control unit 3, 4 in the control state, a state change takes place in such a way that the control unit 3, 4 previously in the monitoring state is placed into the control state and the control unit from which the control state has been withdrawn is placed into a fault state. The monitoring signal of a control unit 3, 4 which is in the fault state is not taken into account by the activation unit 5.

The switching of the states of the control units 3, 4 can in this case be implemented with the aid of the switching unit 8, 9 actuated by the activation unit 5, wherein simply a switch of the control unit to be switched into the control state is closed and the switch of the control unit regarded as faulty is opened, so that the control signals of the control unit regarded as acting faultily are no longer guided to the actuator 2.

If the system 100 is part of an aircraft, it may be particularly advantageous if the external source 7 is a flight control computer and the actuator serves to actuate a flight control surface or the aircraft landing gear.

In such a case, the external source 7 can be configured to conclude a malfunction of the actuator if the actuator setpoint signal delivered to the control device 1 leads to a reaction of the aircraft which deviates from the expected reaction. In order to determine the reaction of the aircraft, it is optionally not necessary to use a state signal of the actuator; rather, it is sufficient to detect other state parameters of the aircraft which are indirectly influenced by the actuator.

By means of the disclosure, a control device 1 as well as a system 100 comprising the control device 1 can be implemented which, compared with comparable control devices from the prior art, entails lower costs, lower weight, and fewer components and, associated therewith, lower energy consumption.

### LIST OF REFERENCE SIGNS

1: Control device
2: Safety-critical actuator
2A: State signal
3: First control unit
3A: Control signal of control unit 3
3B: Monitoring signal of control unit 3
4: Second control unit
4A: Control signal of control unit 4
4B: Monitoring signal of control unit 4
5: Activation unit
6: Signal input
7: External source
7A: Assignment signal
7B: Actuator setpoint signal/state signal
8: First switching unit
9: Second switching unit
100: System

1. A control device for a safety-critical actuator, comprising:
a first control unit which is configured to output a control signal for actuating the actuator and a monitoring signal on the basis of at least one state signal of the actuator fed back to the first control unit,
a second control unit which is configured to output a control signal for actuating the actuator and a monitoring signal on the basis of at least one state signal of the actuator fed back to the second control unit, and
an activation unit which is configured to place either the first control unit or the second control unit into a control state (CON), in which the output control signal is forwarded to the actuator, and to place the other control unit into a monitoring state (MON), in which the output control signal is not forwarded to the actuator,
wherein the activation unit is configured to receive and evaluate the monitoring signal of the first control unit and the monitoring signal of the second control unit in order, depending thereon, to assign the control state of the first control unit or of the second control unit, wherein the activation unit has a signal input for receiving at least one assignment signal from at least one external source, and
wherein the activation unit is configured to switch the control state from the control unit in the control state to the control unit in the monitoring state when both the monitoring signal of the control unit in the monitoring state and the assignment signal of the external source indicate a malfunction of the control unit in the control state.

2. The control device according to claim 1, wherein the first control unit and the second control unit are designed redundantly with respect to one another, and/or each have a signal input for receiving an actuator setpoint signal from the external source.

3. The control device according to claim 1, wherein the activation unit is designed separately from the two control units or can be designed integrated into one or both of the control units.

4. The control device according to claim 1, wherein the activation unit is configured to carry out, as a function of the assignment signal, an initial assignment of control state and monitoring state to the first control unit and the second control unit.

5. The control device according to claim 1, wherein, after a switching of the control state from the control unit in the control state to the control unit in the monitoring state, the activation unit is configured to place the control unit from which the control state has been withdrawn into a fault state (FAIL).

6. The control device according to claim 1, wherein the activation unit comprises a first switching unit, which is configured to establish or interrupt a signal connection between the first control unit and the actuator, and a second switching unit, which is configured to establish or interrupt a signal connection between the second control unit and the actuator.

7. The control device according to claim 1, wherein the safety-critical actuator is an actuator in an aircraft.

8. A system for actuating a safety-critical actuator, comprising:
the control device according to claim 1, and
an external source which is coupled to the activation unit via the signal input.

9. The system according to claim 8, wherein the external source is configured to transmit an actuator setpoint signal for actuating the actuator to the device.

10. The system according to claim 8, wherein the external source is configured to send an assignment signal via the signal input to the activation unit in order to initially assign the control state (CON) and the monitoring state (MON) to the first control unit and the second control unit, respectively.

11. The system according to claim 8, wherein the external source is configured to send, via the signal input, an assignment signal to the activation unit which indicates a malfunction of the control unit in the control state.

12. The system according to claim 8, wherein the activation unit is configured to switch the control state from the control unit in the control state to the control unit in the monitoring state only when both the monitoring signal of the control unit in the monitoring state and the assignment signal of the external source indicate a malfunction of the control unit in the control state.

13. The system according to claim 8, wherein the external source is a flight control computer which is coupled to the control device via a communication bus.

14. The system according to claim 8, further comprising an actuator which is configured to receive a control signal from a control unit in the control state and to send at least one state signal to both the first control unit and the second control unit.

15. An aircraft having the device according to claim 1, wherein the aircraft is an airplane.

16. The control device according to claim 2, wherein the first control unit and the second control unit are designed heterogeneously redundant or homogeneously redundant with respect to one another.

17. The control device according to claim 5, wherein the monitoring signal of a control unit in the fault state is not taken into account by the activation unit when assigning the control state.

18. The control device according to claim 6, wherein the first switching unit and the second switching unit are each designed as a switch, relay, or the like actuated by the activation unit.

19. The control device according to claim 7, wherein the safety-critical actuator is an actuator in a high-lift system, or an actuator for adjusting a primary flight control surface, a flight control element, or an aircraft landing gear of an aircraft.

20. The system according to claim 9, wherein both the first control unit and the second control unit receive the identical actuator setpoint signal for outputting a control signal based thereon.
